(19) United States
(12) Patent Application Publication
(10) Pub. No.: US 2026/0109550 A1
(43) Pub. Date: Apr. 23, 2026

(54) Crossbelt Sorter

(71) Applicant: Interroll Holding AG, Sant' Antonino (CH)

(72) Inventors: Thomas Eisinger, Hückelhoven (DE); Florian Funk, Hückelhoven (DE)

(21) Appl. No.: 19/113,911

(22) PCT Filed: Sep. 25, 2023
(86) PCT No.: PCT/EP2023/076328

§ 371 Date: Mar. 21, 2025

(30) Foreign Application Priority Data
Sep. 28, 2022 (EP) 22198526.0

(51) Int. Cl. B65G 47/46; B07C 3/08; B65G 17/34

(52) U.S. Cl. CPC B65G 47/46; B07C 3/082; B65G 17/345; B65G 2811/0647; B65G 2811/098

(57) ABSTRACT

Crossbelt sorter (1), adapted to sort an object (9) into one of a plurality of discharge stations (14); the crossbelt sorter (1) comprising a plurality of crossbelt carts (11); the crossbelt carts (11) are movable along a conveying direction (R) on a circumferentially closed conveying track (13); the crossbelt cart (11) comprising a crossbelt (12); wherein the crossbelt (12) provides a conveying surface for supporting an object (9) to be conveyed; the crossbelt (12) is moveable relative to the crossbelt cart (11) in a traverse direction (Q) traverse to the conveying direction (R); the crossbelt sorter (1) is adapted to transfer said object (9) from the conveying cart (11) selectively into one of the plurality discharge stations (14) by selectively driving said crossbelt (12) in the traverse direction (Q); wherein for driving said crossbelt (12) said crossbelt cart (11) has a drive wheel (41) which is adapted to engage with a friction bar (31); said friction bar (31) is located stationary along the track (13) and transferable between a driving position and a disengaged position, characterized in that the crossbelt sorter (1) is adapted to vary an actuation position (Y0, Y1, Y2) within the range of said friction bar (31).

### CROSS REFERENCE TO RELATED APPLICATIONS

This application is the U.S. national stage of International Application No. PCT/EP2023/076328, filed on 2023-09-25. The international application claims the priority of EP 22198526.0 filed on 2022-Sept.-28; all applications are incorporated by reference herein in their entirety.

### BACKGROUND

The invention refers to a crossbelt sorter.

A generic crossbelt sorter is shown in U.S. Pat. No. 6,273,268 B1 (references in this paragraph refer to this document). The crossbelt sorter comprises a plurality of crossbelt carts which are movable along a conveying direction on a circumferentially closed conveying track. A crossbelt on the crossbelt cart provides a conveying surface for supporting an object to be conveyed. The crossbelt is moveable relative to the crossbelt cart in a traverse direction traverse to the conveying direction. For driving said crossbelt the crossbelt cart has a drive wheel which is adapted to be selectively engaged by a friction bar; here, the movement of the crossbelt is effected by means of friction bars installed in a fixed location on the travel path, which can be transferred between a driving position and a disengaged position. Resetting springs (FIG. 5, reference sign 40) act on the friction bars into their disengaged position (col. 3, I. 61-67; col. 6, I. 2-6; claim 9). In the driving position the friction bar gets in contact with a drive wheel on the crossbelt cart, resulting in a drive motion of the drive wheel. The drive wheel is connected with the crossbelt, leading to a drive operation of the crossbelt. The actuation of the friction bar into the driving position is performed by an electric or a pneumatic actuator, against the spring forces.

US 2009/0057100 A1 discloses a cross belt sorter where the drive wheel is constantly in contact with a stationary friction bar. On the crossbelt cart a switchable clutch is provided. The clutch can selectively be switched between an open state and a closed state. In the closed state the clutch provides a drive connection between drive wheel and the crossbelt, so that an object to be conveyed is sorted selectively into one of the discharge stations. In the open state the drive connection is interrupted so that an object remains on the cart.

CN 105 417 109 A discloses an express sorting machine, which includes a frame and a plurality of trolleys. The machine has a trolley driving device including a worm, a cam and a worm drive device. The cam is spirally fixed on the worm.

JP 2005 324902 A discloses an automatic belt sorting device that uses sensors to measure the external shape, color, and presence or absence of blemishes of agricultural products such as fruits and vegetables, and sorts them according to predetermined standards. A drive wheel for belt drive connected to a roller via a gear mechanism is rotatably provided in a direction perpendicular to the axis of the roller, and a sensor is located below the flow line along which the drive wheel moves. A plurality of track members are provided that are driven up and down in response to a signal, and by pushing up the track members in the direction in which they contact the drive wheels, the belt is rotated and placed as the individual conveyance mechanism moves.

Generally, crossbelt sorters use a frictional contact between the crossbelt and the object to accelerate the object in the traverse direction. Delaying effects are to be considered. Those delaying effects depend on the size, the weight and the surface of the conveyed object. In contrast to the crossbelt sorters, there are sorters which use pusher shoes, which positively pushes the objects in the traverse direction, see e.g. pushing shoes 16 in FIG. 1 of U.S. Pat. No. 10,640,302 B2. Due to the positive pushing contact, the delaying effects are not given in such shoe sorters.

All of the above sorters require discrete equipment for activating the movement of the crossbelt, which is located stationary along the conveying track. The stationary equipment constitutes something like a hard programming of the conveying functionality, preventing any dynamic and/or fine adjustments of the sorter behavior.

### SUMMARY

Crossbelt sorter (1), adapted to sort an object (9) into one of a plurality of discharge stations (14);
the crossbelt sorter (1) comprising a plurality of crossbelt carts (11);
the crossbelt carts (11) are movable along a conveying direction (R) on a circumferentially closed conveying track (13);
the crossbelt cart (11) comprising a crossbelt (12);
wherein the crossbelt (12) provides a conveying surface for supporting an object (9) to be conveyed;
the crossbelt (12) is moveable relative to the crossbelt cart (11) in a traverse direction (Q) traverse to the conveying direction (R);
the crossbelt sorter (1) is adapted to transfer said object (9) from the conveying cart (11) selectively into one of the plurality discharge stations (14) by selectively driving said crossbelt (12) in the traverse direction (Q);
wherein for driving said crossbelt (12) said crossbelt cart (11) has a drive wheel (41) which is adapted to engage with a friction bar (31);
said friction bar (31) is located stationary along the track (13) and transferable between a driving position and a disengaged position,
characterized in
that the crossbelt sorter (1) is adapted to vary an actuation position (Y0, Y1, Y2) within the range of said friction bar (31).

### DETAILED DESCRIPTION

It is an object of the present invention to provide an improved sorter in particular with respect of adjustability.

The invention comprises a crossbelt sorter and a method according to the main claims; embodiments are subject of the subclaims and the description.

In an inventive crossbelt sorter the object to be conveyed is accelerated in the traverse direction in particular merely by a frictional contact between the crossbelt and the object. Consequently no shoe is provided which positively pushes the object in the traverse direction.

The friction bar is located stationary along the track. That means that the driving position of the friction bar cannot be changed during normal operation. The position stationary along the track nevertheless allows the transfer between the driving position and the disengaged position.

When the friction bar is in the disengaged position a drive wheel passing the friction bar is not driven by the friction bar. When the friction bar is in the driving position the drive wheel is driven by the friction bar.

In particular the drive wheel is permanently connected to the crossbelt in particular in a manner, so that driving the drive wheel by the friction bar leads to driving the crossbelt.

In particular a rearward position along the track is a position which is passed by the cart at an earlier point in time than a forward position; in other words: the forward position is located downstream of a rearward position.

A stationary position along the track means that the driving position in direction of the track may not be amended, in particular the position of stationary components are not changed during the normal operation; during installation and maintenance the position may be adapted.

The inventive crossbelt sorter has the advantage that during operation the operation characteristics can be optimized. In contrast to the prior art the activation position can be amended to adapt the cross belt sorter to various framework or changing requirements without the need to reposition the overall position of the friction bar at all.

### BRIEF DESCRIPTION OF THE DRAWINGS

The invention is explained in more detail below with reference to the figures; herein shows:

FIG. 1 a crossbelt sorter in top view;

FIG. 2 a sectional view of the cross belt cart of the crossbelt sorter of FIG. 1 according to the line II-II in FIG. 1;

FIG. 3 a top view of a section of a crossbelt sorter according to the prior art in different situations;

FIG. 4 a top view of a section of a crossbelt sorter according to a comparative embodiment in different situations;

FIG. 5 a top view of a section of an inventive crossbelt sorter in a first embodiment in different situations;

FIG. 6 a top view of a section of an inventive crossbelt sorter in a second embodiment in different situations;

FIG. 7 a top view of a section of an inventive crossbelt sorter in a third embodiment in different situations;

FIG. 8 a diagram showing the relation between the cart speed and the actuation position in the inventive crossbelt sorter.

### DETAILED DESCRIPTION OF THE PREFERRED EMBODIMENTS

FIG. 1 shows a crossbelt sorter 1. The crossbelt sorter 1 comprises a plurality of crossbelt carts 11, which travel circumferentially in a conveying direction R along a closed track 13. On top of each of the carts 11 a crossbelt 12 is provided. A top surface of the crossbelt 12 provides a conveying surface for supporting an object 9 to be conveyed.

A plurality of discharge stations 14 are provided, at which the object 9 can selectively be removed from the crossbelt cart 11 and conveyed to a discharge area 14 provided laterally of the crossbelt cart 11. For this purpose, the crossbelt 12 is set in motion on the crossbelt cart 11 in a transverse direction Q transverse to the conveying direction R. A central controller 2 is controlling the operation of the different actuators within the crossbelt sorter 1.

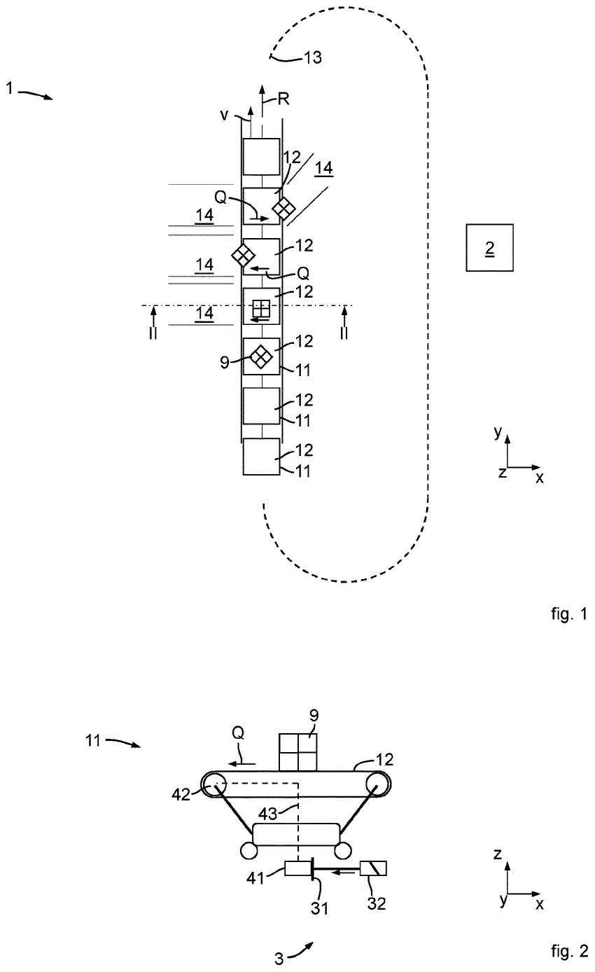

FIG. 2 shows the mechanism for driving the crossbelt 12. Along the track 13 (see FIG. 1) an actuator arrangement 3 is provided having a friction bar 31. The friction bar 31 can be transferred between a driving position and an disengaged position. The actuator arrangement 3 is provided to transfer the friction bar 31 between the driving position and the disengaged position. For amending the position of the friction bar 31 the actuator arrangement 3 has an actuator 32, e.g. a pneumatic or electromechanical actuator.

In the driving position the friction bar 31 gets in frictional contact with a drive wheel 41 on the crossbelt cart 11. Now, due to the relative movement of the drive wheel 41 along the conveying direction R the friction bar 31 sets the drive wheel 41 into rotation.

Via a permanent drive connection 43 (shown merely schematically) the drive wheel 41 is connected to a drive roller 42 driving the crossbelt 12. Consequently, a rotation of the drive wheel 41 results in a drive motion of the crossbelt 12 on top of the cart 11 in the transverse direction Q.

In particular “permanent” means in this context, that a rotation of the drive wheel 41 always leads to a drive power at the crossbelt 12. For the opposite direction, a freewheel mechanism may be provided which hinders the crossbelt 12 to drive the drive wheel 41.

In the disengaged position the friction bar 31 is not in a frictional contact with the drive wheel 41 when no drive power is provided to the crossbelt 12, so that an object 9 located on top of the crossbelt 12 keeps its location within the crossbelt cart 11.

Finally the crossbelt 12 is driven by a drive roller 42, which is permanently connected to the drive wheel 41 and the crossbelt 12 so that a rotation of the drive wheel 41 automatically results in a movement of the crossbelt 12.

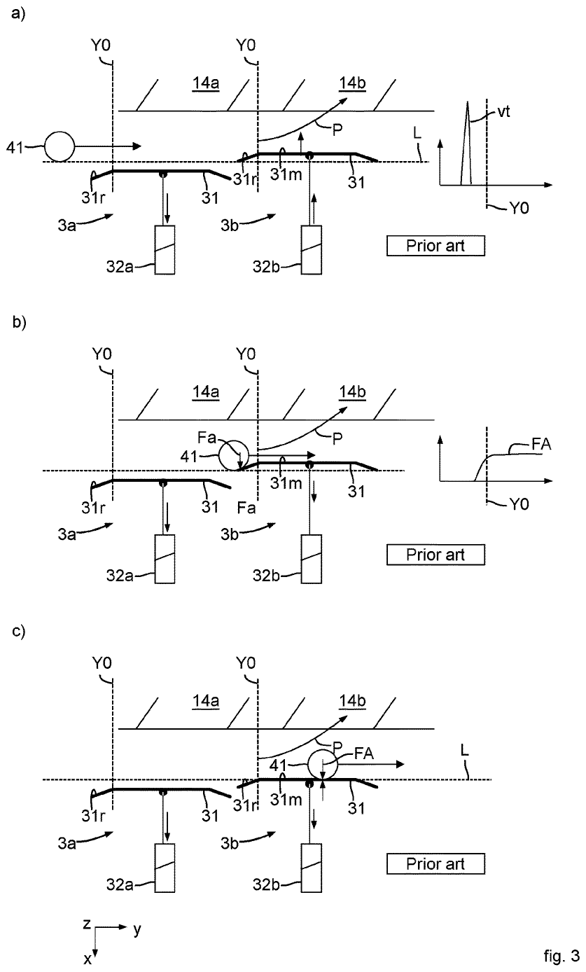

FIG. 3 shows two actuator arrangements 3a, 3b of the prior art. Each of the actuator arrangements 3a, 3b is allocated to a separate of one of a plurality of discharge destinations 14a, 14b. A first actuator arrangement 3a is in a passive state and the related friction bar 31 is in a disengaged position. With the help of the dotted auxiliary line L it becomes apparent, that the first friction bar 31 of the first actuator arrangement 3a will not contact the drive wheel 41 when the drive wheel 41 is passing the friction bar 31. In contrast thereto a second actuator arrangement 3b is in an active state and the related friction bar 31 is in a driving position. With the help of the dotted auxiliary line L it becomes apparent, that the first friction bar 31 will contact the drive wheel 41 when the drive wheel 41 is passing the friction bar 31 (FIGS. 3b, 3c).

The friction bar 31 comprises a main section 31m and an approach ramp 31r.

FIG. 3a shows a first phase when the drive wheel 41 is still at a distance to the friction bar 31 in the driving position (of second actuator arrangement 3b). Thereby the friction bar 31 protrudes into the path of the drive wheel 41.

The friction bar 31 and the drive wheel 41 are adapted to each other so that when passing the friction bar 31 in its driving position the drive wheel 41-in a second phase—initially contacts the approach ramp 31r (FIG. 3b).

In the second phase the approach ramp 31r serves for guiding the drive wheel 41 when contacting the friction bar 31. Now the drive wheel 41 pushes the friction bar 31 back in direction of the disengaged position. In particular due to a certain resilience and slippage the drive wheel 41 has the opportunity to smoothly start rotation during the second phase.

After a first contact between the drive wheel 41 and the friction bar 31, an actuating force FA between the drive wheel and the friction bar (here the approach ramp 31r) is smoothly increasing.

In a subsequent third phase the drive wheel 41 contacts the main section 31m (FIG. 3c) at actuation position Y0. Now the actuating force FA has reached in main its maximum level and the friction bar 31 provides full frictional contact with the drive wheel 41, leading to very low or no slippage between the friction bar 31 and the drive wheel 41. In particular only when the drive wheel 41 contacts the main section 31m the full frictional contact providing the full drive power for the drive wheel 41 and the crossbelt 12.

As a consequence, as long as the drive wheel 41 needs to firstly contact an approach ramp 31r, the position of the approach ramp 31r defines a start position and the position, where driving of the drive wheel 41 can be started. As a consequence the start position also defines the following actuation position Y0, in which the actuation force FA has reached in main the full amount.

In case the actuator arrangement 3 is in the driving position, driving the drive wheel 41 and consequently the crossbelt 12 for each discharge destination 14 is on full speed when the drive wheel 41 arrives at a foremost actuation position Y0 of the friction bar main section 31m. This foremost actuation position Y0 is in a fixed relation to the related discharge destination 14a, 14b. Consequently the actuation position Y0 defines a fixed relation to a position, where acceleration of the object 9 in transverse direction Q (see FIG. 1) is started (which can be anywhere at the approach ramp).

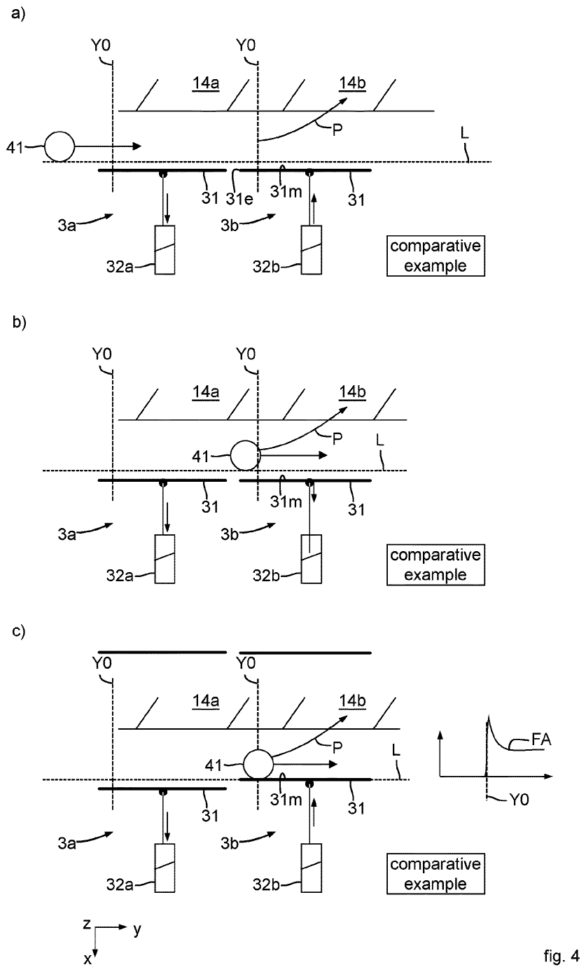

In the embodiment according to FIG. 3 it is essential, that the drive wheel 41 initially contacts the friction bar 31 at the approach ramp 31r, to enable smooth acceleration of the drive wheel 41. As a comparative example FIG. 4 shows a situation which is not possible in the embodiment according to FIG. 3. For comparison reasons the approach ramp 31r is omitted; instead the main section 31m is designed longer.

The first phase shown in FIG. 4a is similar to the first situation shown in FIG. 3. Here in a first phase the drive wheel 41 is at a distance to the friction bar 31 of the second actuator arrangement 3b. Contrary to the embodiment of FIG. 3 the friction bar 31 of the second actuator arrangement 3b is in a first phase in the disengaged position.

Without an approach ramp 31r, the drive wheel 41 needs to be in an initially overlapping condition with the friction bar 31, as shown in FIG. 4b. Otherwise the drive wheel 41 would strongly hit the foremost edge leading to a heavy and unsane stroke.

Only when the drive wheel 41 already starts passing the friction bar 31 the friction bar 31 can be transferred into the drive position (third phase in FIG. 4c) hitting the drive wheel 41 with a heavy stroke. This leads initially to a sudden hard strike of the friction bar 31 to the drive wheel 41 and the bearings of the drive wheel 41, resulting in a low service lifetime. To avoid said stresses the present application provides ideas for improvement, with the help of the following figures.

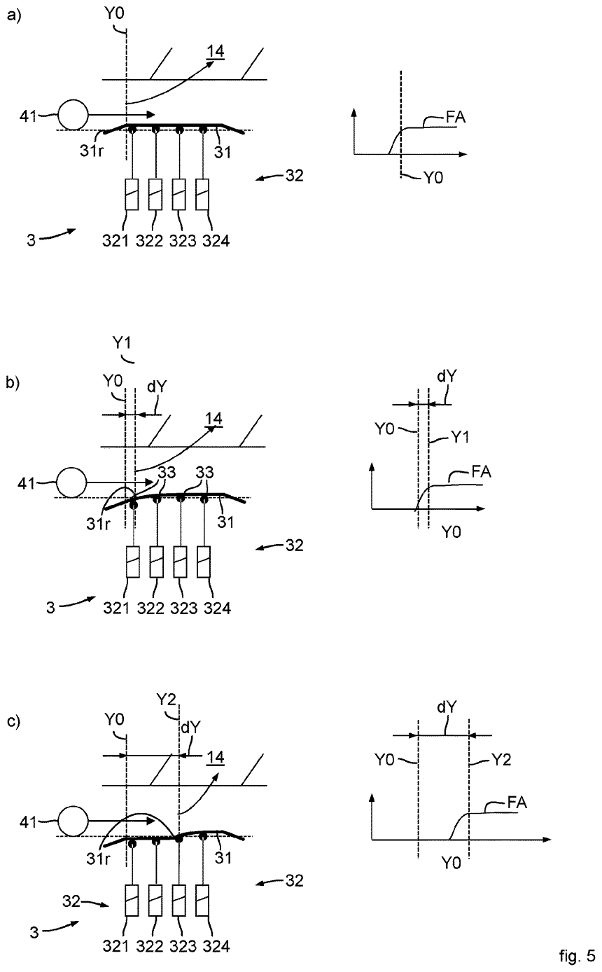

FIG. 5 shows in different situations an improved actuator arrangement 3, which can replace each of the actuator arrangements 3a, 3b shown in FIG. 3.

Here each actuator 32 of the actuator arrangement 3 has a plurality of sub-actuators 321-324. The friction bar 31 is flexible having a certain elasticity and is adapted to change its shape. The actuator 32 (here the sub-actuators 321-324 of the actuator 32) is adapted to change the shape of the friction bar 31.

Accordingly the actuator 32 selectively pushes selected sections 33 of the friction bar 31 into the driving position, where other sections 33 may remain in the disengaged position.

In FIG. 5a the sub-actuators 321-324 of actuator 32 act as the actuator 32b shown in FIG. 3 and push the friction bar 31 completely in the driving position. So in the situation of FIG. 5a the drive wheel 41 is driven at the foremost driving position Y0, where also an approach ramp 31r is provided providing the same effect as the arrangement in FIG. 3.

In FIG. 5b, a first section of the friction bar 31 is held in the disengaged position where the remaining subsequent sections are pushed by the actuator 32 in the driving position. Consequently an actuation position Y1 where the drive wheel 41 is driven by friction bar 31 is shifted backwards in conveying direction by a position shift dY. The flexible friction bar provides also an approach ramp 31r in front of actuation position Y1, providing the same smooth ramp up of the actuating force FA as in front of actuating position Y0.

Same applies to FIG. 5c. Here a further section 33 of the friction bar 31 is held in the disengaged position where the remaining subsequent sections 33 are pushed by the actuator 32 in the driving position. Consequently an actuation position Y2 where the drive wheel 41 is driven by friction bar 31 is shifted backwards in conveying direction by another position shift dY. The flexible friction bar 31 provides also an approach ramp 31r in front of actuation position Y2, providing the same smooth ramp up of the actuating force FA as in front of above described actuation positions Y1, Y0.

The friction bar 31 is made from an elastic material, in particular the friction bar 31 is a spring steel plate or a hard rubber plate.

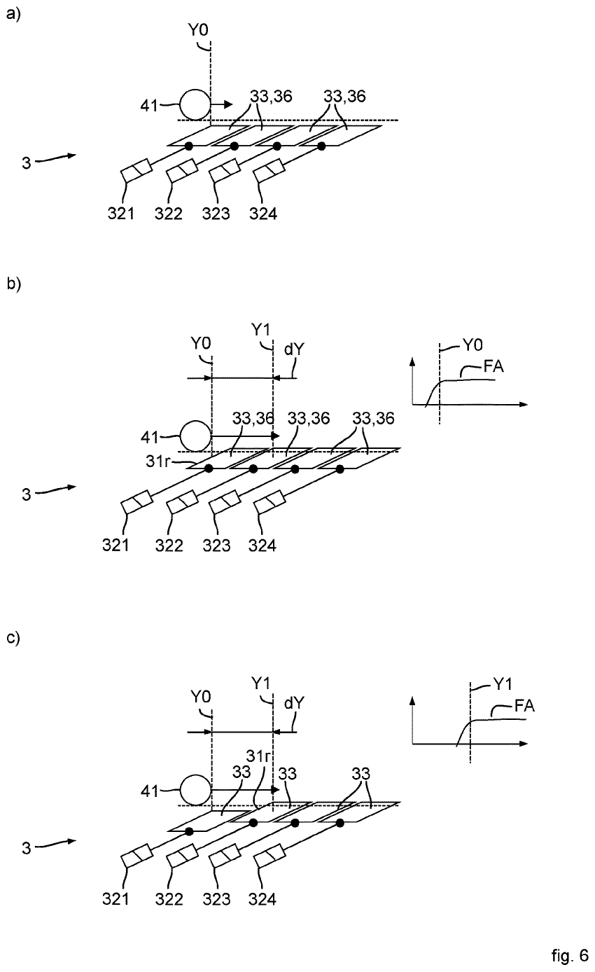

FIG. 6 shows an alternative embodiment. The friction bar 31 has a plurality of separate sections 33 each comprising separate cams 36, which are arranged along the direction of the drive wheel 41. Each section 33 is selectively actuated by a dedicated sub-actuator 321-324 and can individually be transferred between the driving position and the disengaged position.

In case that two or more adjacent cams 36 are located in the driving position, those cams 36 forming said sections 33 establish a common friction bar 31 located in the driving position.

Here each of the sections 33 are provided with their own approach ramp 31r. So independent of the selection of sections 33, which are held in the driving position, the drive wheel 41 will always hit the relevant cam 36 at a respective approach ramp 31r, resulting in the smooth increase of the actuating force FA.

FIG. 6a shows a situation where all cams 36 are in the disengaged position.

FIG. 6b shows a situation, where all sections 33 are held in the driving position. Full actuating force with smooth increase will be at actuation position Y0. The drive wheel 41 will contact the approach ramp 31r at first cam 36 to smoothly increase the actuating force FA before actuation position Y0.

FIG. 6c shows a situation, where a first one of the cams 36 is in the disengaged position and all other cams 36 are held in the driving position. Full actuating force FA with smooth increase will be at actuation position Y1. The drive wheel 41 will contact the approach ramp 31r at the second cam 36 to smoothly increase the actuating force FA before actuation position Y1.

The friction bar 31 is made from a plurality of separate cams 36, which are arranged along the direction of the drive wheel 41. Each cam 36 is selectively actuated by a dedicated sub-actuator 321-324 and can individually be transferred between the driving position and the disengaged position.

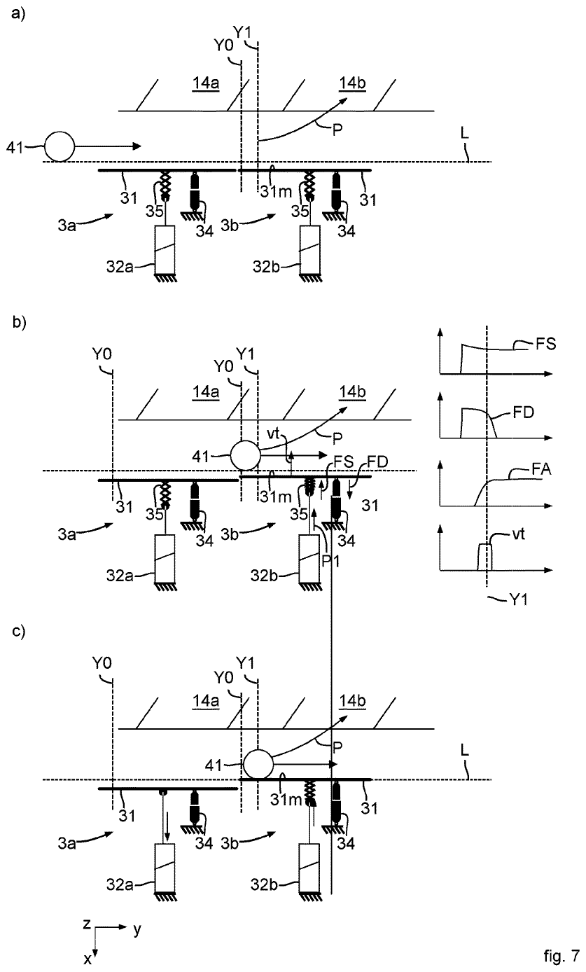

FIG. 7 shows an alternative embodiment, which is based on the comparative example of FIG. 4. So features described with reference to FIG. 4 are also applicable to the embodiment of FIG. 7.

As in FIG. 4, there is no approach ramp 31r required (however it may be possible that there is nevertheless an approach ramp 31r). The actuator arrangement 3 comprises a damper 34. The damper 34 dampens the movement of the friction bar 31 during the transfer from the disengaged position to the driving position. FIG. 7a shows the friction bars 31 of both actuator arrangements 3a, 3b in the disengaged position.

In a subsequent sorting operation, the passing drive wheel 41 is to be accelerated by the friction bar 31 of second actuator arrangement 3b. FIG. 7b shows a situation, where the drive wheel 41 is already passing said friction bar 31 of second actuator arrangement 3b. Now the actuator 32b is operated and pushes the friction bar 31 into the driving position. Here the damper 34 provides a damping force FD, which hinders the friction bar 31 to be transferred promptly into the driving position.

Initially the actuator 32b compresses a spring 35 which is located between the actuator 32 and the friction bar 31. Instead of directly transferring the friction bar 31 in to the driving position by the actuator 32b, the spring 35 provides a main spring force FS, which constantly urges the friction bar 31 against the damping force FD into the driving position, without being forced in the driving position.

As a result the friction bar 31 is smoothly transferred with a transfer speed vt into the driving position and consequently the actuating force FA is increased smoothly mainly in the same manner as in the embodiments of FIGS. 3, 5 and 6 (in comparison thereto, as shown in FIG. 3a the transfer speed vt in the prior art embodiment is much larger and the time in which transfer happens is much shorter, leading to a non-smooth transfer at a certain time before the drive wheel 41 is passing the friction bar 31).

The spring 35 and the damper 34, which are interacting with each other, form a speed control mechanism, controlling the speed, in particular the speed profile, by which the friction bar 31 is transferred into the driving position. The actuator 32 can be part of the speed control mechanism.

So by varying the time, where the actuator 32b is operated and starts compressing the spring 35, the actuation position Y1, in which full actuating force FA is provided can be easily controlled. So it is possible to amend the actuation position Y1 at will within a certain range of influence of the actuator arrangement 3, without the need to perform structural adaptions to the actuation position of the friction bar 31 (see above FIG. 3).

Finally in FIG. 7c the friction bar 31 is fully located in the driving position, so that full frictionally contact between the friction bar 31 and the drive wheel 41 is established at actuation position Y1.

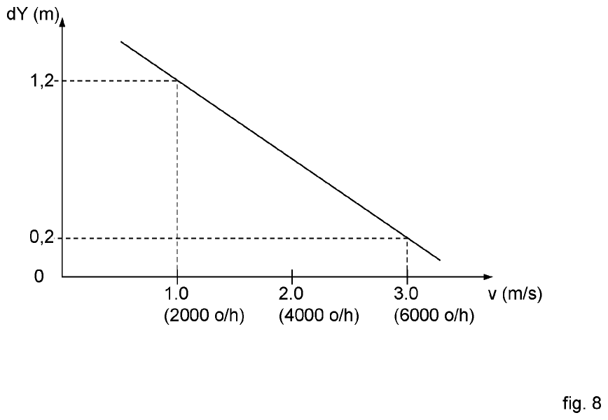

FIG. 8 shows a diagram. Here “v” defines a travel speed, at which the carts 11 travel along the track 13 (see FIG. 1).

In an inventive usage of the sorter 1 a travel speed v of the sorter carts 11 can be adapted. The travel speed v correlates linearly with the maximum number of objects 9, which can be sorted per hour. As an example, at a travel speed of 2.0 m/s a maximum of 4000 objects 9 per hour (“o/h”) can be sorted; consequently at a travel speed v of 1.0 m/s a maximum of 2000 o/h can be sorted.

The sorter 1 is adapted to be driven at different capacity conditions. During Christmas trade the utilization of the sorter 1 requires 6000 objects to be sorted per hour, so the carts 11 need to be operated at a travel speed v of 3 m/s. In the summer slump the utilization requires merely 2000 objects to be sorted per hour, so the carts 11 need to be operated at a travel speed v of 1 m/s.

For proper sorting objects 9 into the discharge stations 14, the start point for accelerating the objects is dependent of the travel speed v of the carts 11. To meet the correct discharge station 14 an object 9 needs to be accelerated earlier in case of a high cart travel speed v, than in case of low cart travel speed.

So for proper sorting the object 9 at a travel speed v of 1.0 m/s, an exemplary trigger shift dY is to be set to 1.2 m, whereas at a travel speed v of 3.0 m/s, an exemplary trigger shift dY is to be set to 0.2 m. In other words: at a travel speed v of 3.0 m/s, the clutch 5 is to be closed at a actuation position 1.0 m ahead / earlier compared to a position where the clutch 5 is to be closed at a travel speed v of 1.0 m/s.

FIGS. 3, 4, 5, 6, 7 show a section of the sorter in the area of the friction bars 31 in top view. Here merely the drive wheel 41 of the cart 11, the actuator arrangement 3 with friction bar 31 and the discharge stations 14 are shown schematically. To allow a better view on these components the other parts of the carts 11 and the crossbelt 12 are not shown.

### LIST OF REFERENCE NUMERALS

1 crossbelt sorter
2 central controller
3, 3a, 3b actuator arrangement
9 object to be conveyed
11 crossbelt cart
12 crossbelt
13 track
14, 14a, 14b discharge stations
31 friction bar
31r approach ramp
31m friction bar main section
32, 32a, 32b actuator (32 not shown in fig)
321-324 sub-actuator
33 section
34 damper
35 spring
36 cam
41 drive wheel
42 drive roller
43 drive connectionFS damping force
FA actuating force
FD damping force
FS spring force
R conveying direction
Q transverse direction
L auxiliary line
P path
Y0, Y1, Y2 actuation position
dY position shift
V travel speed of crossbelt cart
vt transfer speed of friction bar

1. Crossbelt sorter (1), adapted to sort an object (9) into one of a plurality of discharge stations (14);
the crossbelt sorter (1) comprising a plurality of crossbelt carts (11);
the crossbelt carts (11) are movable along a conveying direction (R) on a circumferentially closed conveying track (13);
the crossbelt cart (11) comprising a crossbelt (12);
wherein the crossbelt (12) provides a conveying surface for supporting an object to be conveyed (9);
the crossbelt (12) is moveable relative to the crossbelt cart (11) in a traverse direction (Q) traverse to the conveying direction (R);
the crossbelt sorter (1) is adapted to transfer said object (9) from the conveying cart (11) selectively into one of the plurality discharge stations (14) by selectively driving said crossbelt (12) in the traverse direction (Q);
wherein for driving said crossbelt (12) said crossbelt cart (11) has a drive wheel (41) which is adapted to engage with a friction bar (31);
said friction bar (31) is located stationary along the track (13) and transferable between a driving position and a disengaged position,
characterized in
that the crossbelt sorter (1) is adapted to vary an actuation position (Y0, Y1, Y2) within the range of said friction bar (31).

2. Crossbelt sorter (1) according to claim 1,
characterized in
that upon actuation the crossbelt-sorter (1) is adapted so that the friction bar (31) provides in a defined manner an increasing actuating force (FA) between the friction bar (31) and the drive wheel (41).

3. Crossbelt sorter (1) according to claim 1,
characterized in
that said increasing actuating force (FA) is provided by an approach ramp (31r) in front of a main section (31m) of the friction bar (31);
in particular, the increasing actuating force (FA) occurs when the drive wheel (41) is initially contacting the approach ramp (31r) and subsequently contacting the main section (31m).

4. Crossbelt sorter (1) according to claim 3,
characterized in
that the cross belt sorter (1) is adapted so that the position of the approach ramp (31r) along the track (13) can be varied during normal operation.

5. Crossbelt sorter (1) according to claim 4,
characterized in
that the friction bar (31) has a plurality of sections (33), which individually can be transferred into the driving position,
where depending on the selection of sections (33), which are transferred into the driving position, a position of an approach ramp (31r), which is initially contacting the drive wheel (41), is defined.

6. Crossbelt sorter (1) according to claim 5,
characterized in
that a plurality of sections (33) are formed integrally by a single flexible friction bar (31).

7. Crossbelt sorter (1) according to claim 5,
characterized in
that the plurality of sections (33) are formed by separate section members, particular cam (36) members.

8. Crossbelt sorter (1) according to claim 1,
characterized in
that an increasing actuating force (FA) is provided by an actuator (32) and a speed control mechanism (34, 35),
the speed control mechanism (34, 35) is adapted to control a transfer speed (vt) by which the friction bar (31) is transferred into the driving position.

9. Crossbelt sorter (1) according to claim 8,
characterized in
said speed control mechanism (34, 35) comprises a damper (34),
the damper (34) is adapted to provide a damping force (FD) counteracting the transfer of the friction bar (31) into the driving position;
wherein the damping force (FD) is depending on the transfer speed (vt) in a manner that a larger transfer speed (vt) causes a larger damping force (FD).

10. Method of operating a crossbelt sorter (1),
the crossbelt sorter (1) comprising a plurality of crossbelt carts (11);
the crossbelt carts (11) are moving along a conveying direction (R) on a circumferentially closed conveying track (13) at a travel speed (v);
the crossbelt cart (11) comprising a crossbelt (12);
wherein the crossbelt (12) provides a conveying surface for supporting an object (9) to be conveyed (9);
the crossbelt (12) is selective moving relative to the crossbelt cart (11) in a traverse direction (Q) traverse to the conveying direction (R);
the crossbelt sorter (1) transfers said object (9) from the conveying cart (11) selectively into one of the plurality discharge stations (14) by selectively driving said crossbelt (12) in the traverse direction (Q);
wherein the crossbelt (1) is driven by a drive wheel (41), the drive wheel (41) is selectively driven by a friction bar (31) at an actuation position (Y0, Y1, Y2), wherein the friction bar (31) is located stationary along the track (13) and can selectively be transferred between a driving position and a disengaged position,
the method comprising the following steps:
amending a sorting characteristic of the crossbelt sorter (1) in particular during normal operation of the crossbelt sorter (1),
thereby adjusting the actuation position (Y0, Y1, Y2) of a selected friction bar (31) without amending the position of the friction bar (31) along the track (13).

11. Method according to claim 10, wherein amending the sorting characteristic comprises amending the travel speed (v) of the crossbelt cart (11);
whereby the actuation position (Y0, Y1, Y2) is amended in dependency of the amended travel speed (v).

12. Method according to claim 11, wherein said actuation position (Y0, Y1, Y2)
is shifted to a more forward position along the track (13) in case the travel speed (v) is reduced,
is shifted to a more rearward position along the track (13) in case the travel speed (v) is increased.

13. Method according to claim 10 to operate a crossbelt sorter (1) according to claim 1.
